(19) United States
(12) Patent Application Publication
(10) Pub. No.: US 2010/0268729 A1
(43) Pub. Date: Oct. 21, 2010

(54) MULTIMEDIA SYNTHETIC DATA GENERATING APPARATUS

(75) Inventors: Yusuke Nara, Osaka (JP); Junya Tsutsumi, Tokyo (JP); Junichi Nishiyama, Tokyo (JP); Manabu Kawamoto, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: MegaChips Corporation, Osaka-shi (JP); Acrodea, Inc., Tokyo (JP)

(21) Appl. No.: 12/741,377

(22) PCT Filed: Nov. 10, 2008
(86) PCT No.: PCT/JP08/70401

§ 371 Date: May 5, 2010

(30) Foreign Application Priority Data
Nov. 12, 2007 (JP) 2007-292796

(51) Int. Cl. G06F 17/30; G06K 9/00

(52) U.S. Cl. 707/769; 382/118; 707/E17.014

(57) ABSTRACT

A technique for drawing or managing multimedia data by desired groups. In a built-in memory of a cellular phone terminal, thirteen picked-up image data are stored. In tag information of each of the thirteen picked-up image data, information on date and time is recorded when an image of the data is picked up. When a user specifies the range of image pickup date and time, eight picked-up image data that match the specified range of image pickup date and time are selected and synthetic image data is generated from these eight picked-up image data.

### TECHNICAL FIELD

The present invention relates to techniques of processing and managing multimedia data.

### BACKGROUND ART

In these days, blogs wherein personal daily journals are made public and SNSs (Social Network Services) having an purpose of achieving communications among a plurality of persons as well as the elements of blog style have become widespread, and the number of users thereof is on an increase trend. Just then, with speeding up and flat rate of communications of cellular phones, the number of users who use these services through cellular phone terminals is also increasing.

Recently, for differentiation from other companies, besides upload of textual information and still image files, services for upload of multimedia data such as moving image files and services for overlay of comments and decoration on uploaded multimedia data also have become widespread.

Because of such circumstances, cases where general users process multimedia data increasingly occur.

As one of techniques for processing multimedia data is to generate synthetic data called “slide show” wherein a plurality of still image data are switchingly displayed. For example, a function of displaying the still image data stored in a folder as the slide show is incorporated in the OS (Operating System). By using this function, a user can sequentially view the still image data stored in a specific folder with the passage of time.

In Patent Document 1 below, disclosed is a technique of drawing an image with a still image put on a background moving image according to scenario data. The scenario data defines the position and size of the still image to be put on the background moving image.

Patent Document 1: Japanese Patent Application Laid Open Gazette No. 2007-60329

As discussed above, though the occasion where general users process multimedia data increases, a certain level of knowledge and environment are needed in order to edit the multimedia data. Therefore, an edit environment with improved usability also for general users is required. Further, in terminals with small-size screens, such as cellular phone terminals, a complicated edit operation is very burdensome. Therefore, facilitation of the edit environment is desired.

The above-discussed slide show function incorporated in the OS is to switchingly display all the still image data stored in the folder in series. Therefore, even if a lot of irrelevant still image data are stored in the folder, all the still image data are displayed as one slide show. In a case, for example, where a plurality of picked-up image data picked up at a sports meeting and a plurality of picked-up image data picked up at a wedding ceremony are stored in the same folder, all these data are displayed as one slide show.

In order to avoid such a case, it is necessary for the users to manage the still image data, specifically, to store the still image data in different folders by groups such as events. If a large amount of picked-up image data picked up by a digital camera are stored in a folder, an operation of grouping the data to be stored in different folders while browsing the images one by one is very burdensome.

### DISCLOSURE OF INVENTION

The present invention is intended for a multimedia synthetic data generating apparatus. The multimedia synthetic data generating apparatus comprises means for setting a predetermined condition to generate multimedia synthetic data, means for acquiring a plurality of multimedia material selection data that match the predetermined condition which is set, out of a plurality of multimedia material data stored in a storage medium, and means for generating the multimedia synthetic data from the plurality of acquired multimedia material selection data.

A user can thereby generate the multimedia synthetic data only by setting the condition. It is therefore possible to alleviate burdensomeness in the operation of managing the files in the folder.

According to a preferable embodiment of the present invention, the plurality of multimedia material data include picked-up image data, and the range of date and time when the plurality of multimedia material data are picked up is set as the predetermined condition.

The user can thereby manage the picked-up image data by grouping the data in units of image pickup time. The user can also enjoy a memory of the event with one piece of synthetic image data.

According to another preferable embodiment of the present invention, the plurality of multimedia material data include picked-up image data, and an area where the plurality of multimedia material data are picked up is set as the predetermined condition.

The user can thereby manage the picked-up image data by grouping the data in units of visit place. The user can also enjoy a memory of a travel or the like with one piece of synthetic image data.

Therefore, it is an object of the present invention to provide a technique for drawing or managing multimedia data by desired groups.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing a cellular phone terminal in accordance with preferred embodiments;

FIG. 2 is a view showing a manner of generating synthetic image data on the basis of the range of image pickup date and time;

FIG. 3 is a view showing a condition setting screen for the range of image pickup date and time;

FIG. 4 is a view showing a manner of generating the synthetic image data on the basis of an image pickup area;

FIG. 5 is a view showing a condition setting screen for the image pickup area;

FIG. 6 is a view showing an example of the synthetic image data;

FIG. 7 is a view showing a manner of reproducing the synthetic image data according to the continuity of scenes;

FIG. 8 is a view showing a manner where a transition effect is applied to the synthetic image data;

FIG. 9 is a view showing a manner where a display effect according to a face recognition result is applied to the synthetic image data;

FIG. 10 is a view showing a manner where a display effect according to a smile recognition result is applied to the synthetic image data;

FIG. 11 is a view showing a manner where a display effect related to the image pickup area is applied to the synthetic image data;

FIG. 12 is a flowchart showing a process of generating the synthetic image data;

FIG. 13 is a view showing a manner of generating the synthetic image data by using a plurality of terminals; and

FIG. 14 is a flowchart showing a process of generating the synthetic image data.

### BEST MODE FOR CARRYING OUT THE INVENTION

### The First Preferred Embodiment

### Constitution of Cellular Phone Terminal

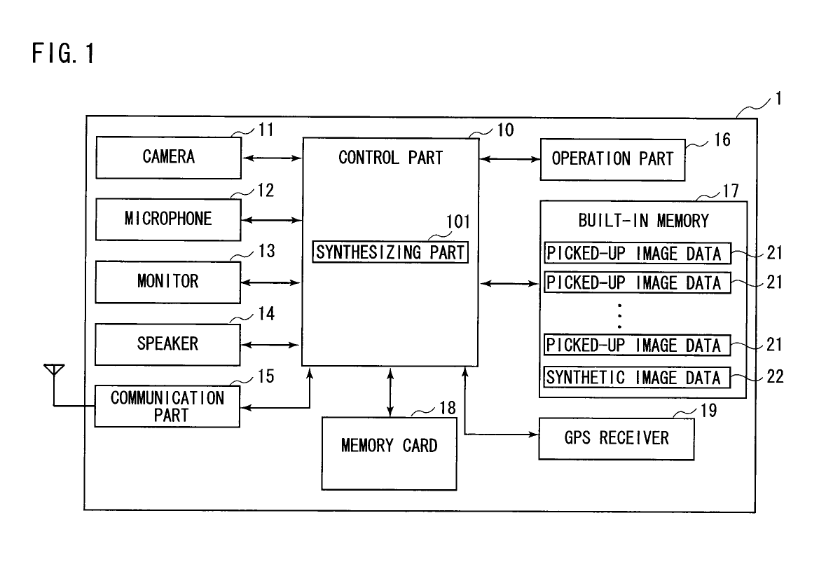

Hereinafter, with reference to figures, the first preferred embodiment will be discussed. FIG. 1 is a block diagram showing a cellular phone terminal 1 in accordance with the first preferred embodiment. The cellular phone terminal 1 is a terminal provided with a camera.

As shown in FIG. 1, the cellular phone terminal 1 comprises a control part 10, a camera 11, a microphone 12, a monitor 13, and a speaker 14. The control part 10 comprises a CPU, a main memory, and the like and performs a general control of the cellular phone terminal 1. The control part 10 comprises a synthesizing part 101. The camera 11 is used to pick up a still image or a moving image. The microphone 12 is used to acquire sound and voice of when the image is picked up or acquire voice in a voice call. The monitor 13 is used to display a picked-up image or display various information such as telephone number or the like. The speaker 14 is used, for reproduction of music, sound effects, and the like, to output the sound and voice recorded together with the image in image reproduction or reproduce the voice in the voice call.

The cellular phone terminal 1 further comprises a communication part 15 and an operation part 16. The communication part 15 performs communications via a telephone network, the interne, and the like. The cellular phone terminal 1 is capable of data communication and voice call by using the communication part 15. The operation part 16 has a plurality of buttons and cursors

The cellular phone terminal 1 further comprises a built-in memory 17 and a memory card 18. In the built-in memory 17, picked-up image data 21, 21 . . . which are picked up by the camera 11 are stored. The picked-up image data 21, 21 . . . are still image data. In the built-in memory 17, synthetic image data 22 generated by combining the picked-up image data 21, 21 . . . is also stored. The synthetic image data 22 is data for slide show wherein the picked-up image data 21, 21 . . . are switchingly displayed. In the first preferred embodiment, though discussion will be made on an exemplary case where the picked-up image data is still image data, the picked-up image data may be moving image data. The memory card 18 is inserted in a card slot of the cellular phone terminal 1. The control part 10 can access various types of data stored in the memory card 18. In the following discussion, in some cases, the picked-up image data 21 are represented by reference signs A to F.

The cellular phone terminal 1 further comprises a GPS receiver 19. The cellular phone terminal 1 can acquire the current position by using the GPS receiver 19. The current position information can be stored in tag information of the image data picked up by the camera 11. With reference to the tag information of the picked-up image data 21, it is thereby possible to specify an area where the image is picked up.

<Method of Generating Synthetic Image Data>

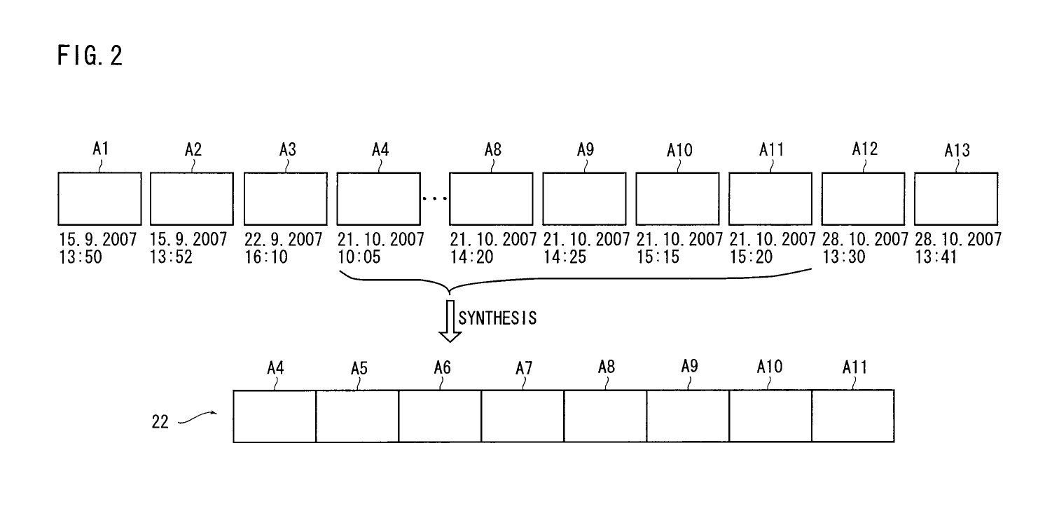

Next, discussion will be made on a method of generating the synthetic image data 22, which is performed by the synthesizing part 101. As shown in FIG. 2, it is assumed that thirteen picked-up image data 21, 21 . . . are stored in the built-in memory 17. Hereinafter, the thirteen picked-up image data 21, 21 . . . are referred to as picked-up image data A1, A2 . . . A13.

In FIG. 2, below the picked-up image data A1, A2 . . . A13, displayed are information of date and time when the picked-up image data A1, A2 . . . A13 are picked up. The image pickup date and time of each picked-up image data can be obtained with reference to the tag information included in the picked-up image data. In the tag information based on the Exif (Exchangeable Image File Format) or the like, for example, the information of image pickup date and time is recorded. Alternatively, there may be a case where the image pickup date and time information of each picked-up image data is obtained with reference to time stamp information of a file.

In the exemplary case of FIG. 2, the picked-up image data A1, A2, and A3 are data picked up on Sep. 15, 2007 and Sep. 22, 2007. The picked-up image data A12 and A13 are data picked up on Oct. 28, 2007. On the other hand, the picked-up image data A4 to A11 are data all picked up on Oct. 21, 2007.

The user uses only the image data picked up at a sports meeting on Oct. 21, 2007 out of the thirteen picked-up image data A1, A2 . . . A13 stored in the built-in memory 17 to generate the synthetic image data 22.

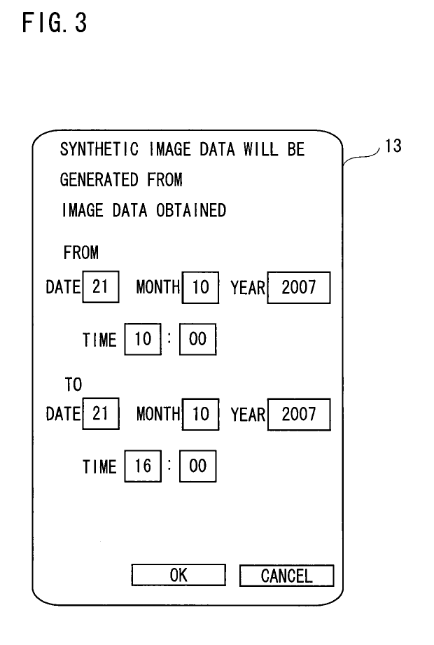

FIG. 3 shows a condition setting screen displayed on the monitor 13. The synthesizing part 101 displays the condition setting screen on the monitor 13 to allow the user to specify a condition for generation of the synthetic image data 22. In the condition setting screen, the user specifies a range of image pickup date and time from 10:00 to 16:00 on Oct. 21, 2007. In other words, the user sets the time period from the starting time to the closing time of the sports meeting. In this state, when the user selects the “OK” button, the synthetic image data 22 using the picked-up image data A4 to A11 is generated as shown in FIG. 2.

The synthetic image data 22 is data for slide display wherein the picked-up image data A4 to A11 are displayed in order of image pickup date and time. In the slide display, usually, the picked-up image data are displayed in order of image pickup date and time from the oldest one. Another setting may be made wherein the picked-up image data are displayed in order of image pickup date and time from the latest one.

Thus, the cellular phone terminal 1 of the first preferred embodiment extracts data that match the condition of the specified image pickup date and time, out of the picked-up image data 21, 21 . . . stored in the built-in memory 17, and generates the synthetic image data 22 for the slide show. It is thereby possible to collect the picked-up image data that match the condition specified by the user, e.g., in units of event, into one piece of synthetic image data 22. Since the user has only to specify the starting date and time and the closing date and time of an event, it is not necessary for the user to perform a burdensome operation, such as management of a large number of files by folders. Further, a user having no complicated knowledge for editing multimedia data can generate the synthetic image data 22 with an easy operation.

For example, by saving the synthetic image data 22 generated from a plurality of picked-up image data picked up at the sports meeting with the name “sports meeting on Oct. 21, 2007”, it is possible to conveniently grasp the content of the file at a glance when the data is reproduced later. The user may delete the picked-up image data 21 which are materials for synthesis and preserve only the synthetic image data 22. In this case, only the synthetic image data 22 with the file names named by events are preserved in the memory and this makes the file management very convenient.

The synthesizing part 101 can also generate the synthetic image data 22 on the basis of image pickup area information.

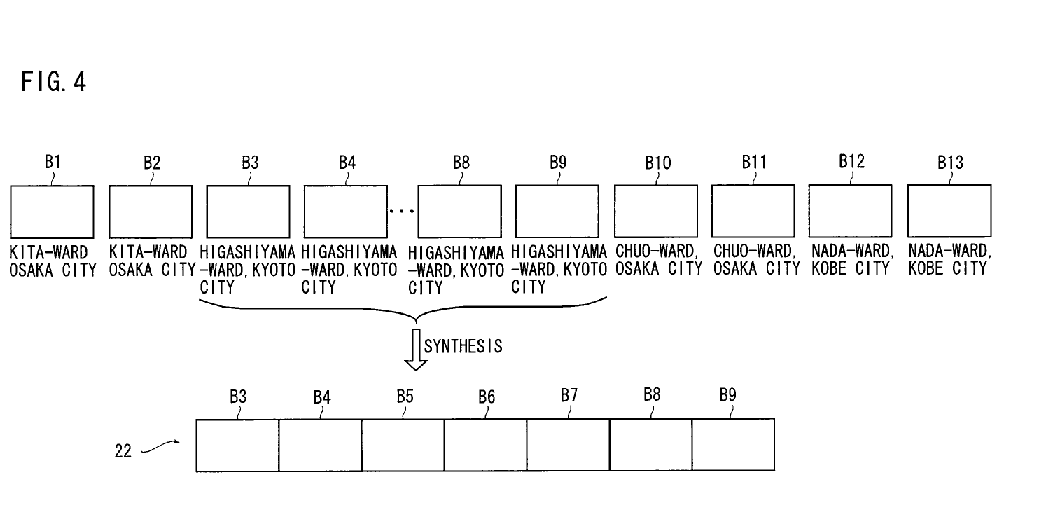

Discussion will be made on a method of generating the synthetic image data 22 on the basis of the image pickup area information. As shown in FIG. 4, it is assumed that thirteen picked-up image data 21, 21 . . . are stored in the built-in memory 17. Hereinafter, the thirteen picked-up image data 21, 21 . . . are referred to as picked-up image data B1, B2 . . . B13.

In FIG. 4, below the picked-up image data B1, B2 . . . B13, displayed are information of areas where the picked-up image data B1, B2 . . . B13 are picked up. The image pickup area information of each picked-up image data can be obtained with reference to the tag information included in the picked-up image data. As discussed above, since the cellular phone terminal 1 has a GPS function, the information on the image pickup area can be recorded in the tag of the picked-up image data 21.

Though longitude and latitude information acquired by using the GPS function is actually recorded in the tag information, for convenience of understanding of discussion, area names specified by the recorded longitude and latitude information are shown in FIG. 4. In the exemplary case of FIG. 4, the picked-up image data B1 and B2 are data picked up at Kita-ward, Osaka City. The picked-up image data B10 and B11 are data picked up at Chuo-ward, Osaka City and the picked-up image data B12 and B13 are data picked up at Nada-ward, Kobe City. On the other hand, the picked-up image data B3 to B9 are data picked up at Higashiyama-ward, Kyoto City.

The user uses only the image data picked up at the sightseeing in Kyoto, out of the thirteen picked-up image data B1, B2 . . . B13 stored in the built-in memory 17 to generate the synthetic image data 22.

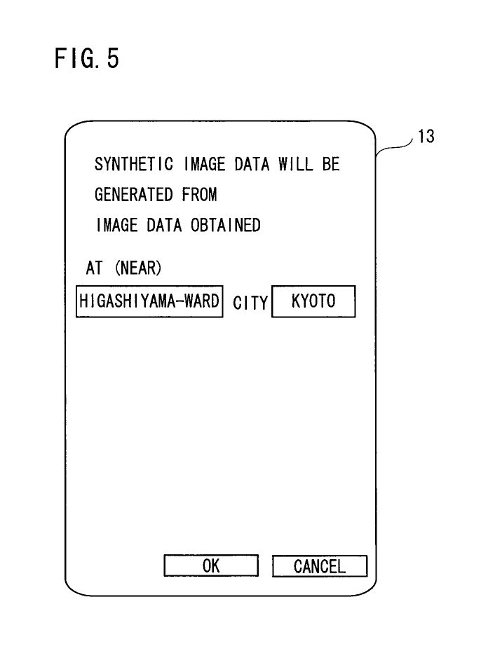

FIG. 5 shows a condition setting screen displayed on the monitor 13. The synthesizing part 101 displays the condition setting screen on the monitor 13 to allow the user to specify the condition for generation of the synthetic image data 22. In the condition setting screen, the user specifies Higashiyama-ward, Kyoto City as the image pickup area. In this state, when the user selects the “OK” button, the synthetic image data 22 using the picked-up image data B3 to B9 is generated as shown in FIG. 4. Further, the synthesizing part 101 has a correspondence table associating the longitude and latitude information with the area names, the names of properties, and the like. From the area name or the name of property which is specified, the synthesizing part 101 selects the picked-up image data picked up in a predetermined range. Further, a correspondence table on a network may be used.

The synthetic image data 22 is data for slide display wherein the picked-up image data B3 to B9 are displayed in order of image pickup date and time. In the slide display, usually, the picked-up image data are displayed in order of image pickup date and time from the oldest one. Another setting may be made wherein the picked-up image data are displayed in order of image pickup date and time from the latest one.

Thus, the cellular phone terminal 1 of the first preferred embodiment extracts data that match the condition of the specified image pickup area, out of the picked-up image data 21, 21 . . . stored in the built-in memory 17, and generates the synthetic image data 22 for the slide show. It is thereby possible to collect the picked-up image data that match the condition specified by the user, e.g., in units of event, into one piece of synthetic image data 22. Since the user has only to specify the visit area, it is not necessary for the user to perform a burdensome operation, such as management of a large number of files by folders. Further, a user having no complicated knowledge for editing multimedia data can generate the synthetic image data 22 with an easy operation.

<Timing of Switching Slides>

As discussed above, the synthesizing part 101 generates the synthetic image data 22 according to the condition set by the user. When the synthetic image data 22 is reproduced, the plurality of picked-up image data 21, 21 . . . constituting the synthetic image data 22 are switchingly displayed in series. Discussion will be made on the timing of switching the slides.

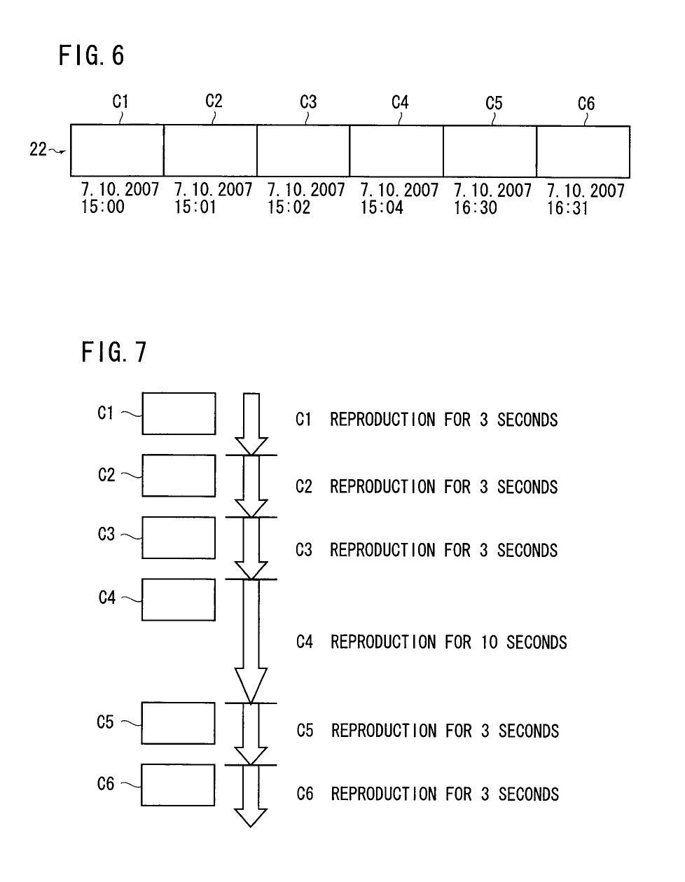

FIG. 6 shows the synthetic image data 22 constituted of six picked-up image data C1 to C6. All the six picked-up image data C1 to C6 are picked up on Oct. 7, 2007. As to the former four picked-up image data C1 to C4 among the six data, the image pickup time centered on the range from 15:00 to 15:04. The latter two picked-up image data C5 and C6 are picked up at 16:30 and 16:31, respectively.

From the distribution of the image pickup time, it is guessed that the former four picked-up image data C1 to C4 are images picked up in series in the same scene. It is also guessed that the picked-up image data C5 and C6 are picked up in almost the same scene after a lapse of a little time. In other words, the picked-up image data C1 to C4 have continuity and the picked-up image data C5 and C6 have continuity. But the continuity is broken between these two groups.

Then, in order to reproduce the picked-up image data grouped by scenes, the synthesizing part 101 sets a reproduction timing for the synthetic image data 22. As shown in FIG. 7, the picked-up image data C1, C2, and C3 are each drawn for three seconds, and then it is the turn of the next slide. The picked-up image data C4 is drawn for ten seconds. After that, the picked-up image data C5 and C6 are each drawn for three seconds. It is thereby possible to reproduce the picked-up image data C1 to C4 as one group of scenes and the picked-up image data C5 and C6 as another group of scenes. There may be another case where the picked-up image data C1 to C4 are each drawn for three seconds and the picked-up image data C5 is drawn for longer time, to thereby indicate a breakpoint of the groups.

Thus, the synthesizing part 101 controls the timing of switching the picked-up image data according to the interval of image pickup times. The user who views the synthetic image data 22 can enjoy the slide show with awareness of the flow of time by the switching timing.

As a matter of course, the function of controlling the switching of slides according to the image pickup time has only to be turned off. In such a case, all the picked-up image data are displayed at regular intervals. Further, the time interval by which a break in the continuity of scenes is determined can be freely set by the user.

<Transition Function>

Next, discussion will be made on a transition function of the synthesizing part 101. As discussed above, the synthesizing part 101 generates the synthetic image data 22 from the plurality of picked-up image data 21, 21 . . . that match the condition set by the user. The synthesizing part 101 can add the transition function giving a special effect on joints of the images of the picked-up image data 21, 21 . . . constituting the synthetic image data 22.

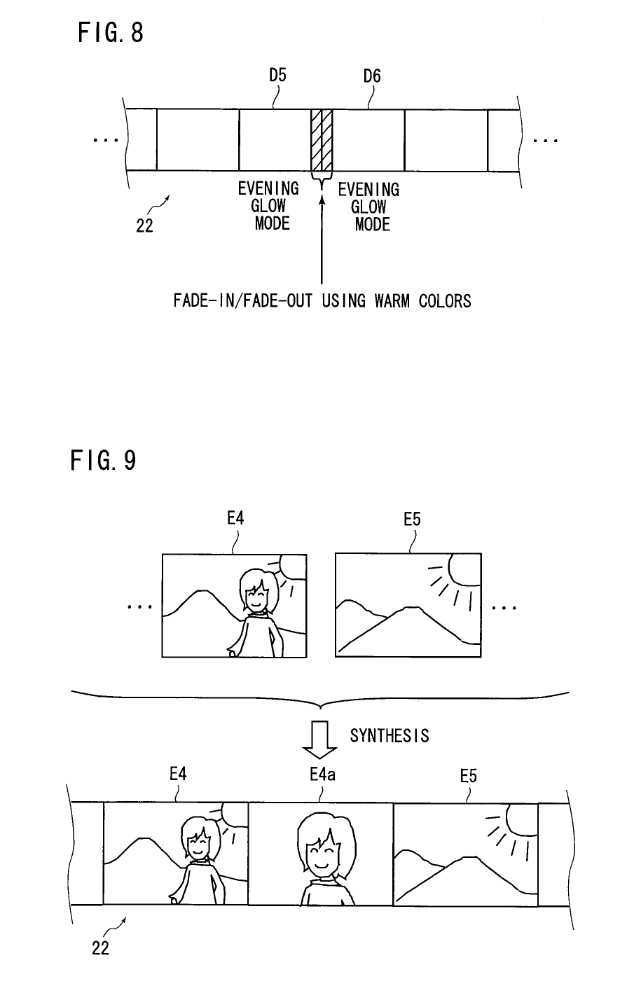

In the synthetic image data 22 of FIG. 8, the transition effect is applied to the joint of the picked-up image data D5 and D6. The synthesizing part 101 refers to the respective tag information of the picked-up image data D5 and D6 to acquire respective photography mode information. Then, the synthesizing part 101 applies the transition effect according to the photography mode information.

In the exemplary case of FIG. 8, in the respective tag information of the picked-up image data D5 and D6, the photography mode information indicating the photography in the “evening glow mode” is recorded. Then, the synthesizing part 101 applies fade-in/fade-out (cross-fade) using warm colors to the joint between the picked-up image data D5 and D6. Specifically, this causes the picked-up image data D5 to fade out to a screen of orange color or the like and causes the picked-up image data D6 to fade in.

Thus, in order to apply the transition according to the photography mode, the synthesizing part 101 has a table associating the photography modes with transition types. The synthesizing part 101 refers to the tag information of the picked-up image data and the table, to thereby determine the transition type to be applied. For example, such settings can be made as to apply the effect of fade-in/fade-out to the joint between images picked up in the portrait mode, to set the transition time of the fade-in/fade-out to be longer for the joint between images picked up in the night scene mode, and to apply slide-in/slide-out to the joint between images picked up in the person mode. Thus, by applying the transition effect according to the photography mode, it is possible to achieve a visual effect caused by scene changes without unpleasantness. Application of the transition effect can be switched to on/off by the user.

<Face Recognition Function>

Next, discussion will be made on a face recognition function of the synthesizing part 101. To the picked-up image data in which a face can be recognized out of the picked-up image data 21 constituting the slide show, the synthesizing part 101 applies a display effect centered on the face.

As one of methods of recognizing a face, for example, there is a case where face coordinates are recorded in advance in the tag information of the picked-up image data 21. Specifically, a face recognition process is applied to the image data picked up by the camera 11 in the control part 10, and the image data is stored in the built-in memory 17 as the picked-up image data 21 with its face coordinates included in the tag information. In this case, the synthesizing part 101 refers to the tag information, and when the face coordinates are recorded, the synthesizing part 101 applies the display effect centered on the face coordinates. Alternatively, the synthesizing part 101 may perform the face recognition process in generation of the synthetic image data 22, to thereby specify the face coordinates.

In the exemplary case of FIG. 9, the synthetic image data 22 including the picked-up image data E4 and E5 is generated. The picked-up image data E4 includes a figure of person and its face coordinates are recorded in the tag information. Then, the synthesizing part 101 inserts enlarged image data E4a obtained by enlarging the face image in between the picked-up image data E4 and the picked-up image data E5, to thereby generate the synthetic image data 22.

When a figure of person appears in the slide show, the above operation makes it possible to draw the data representing a close-up of the person and a visual effect emphasizing the point of the subject is achieved. The user can clearly view the person while seeing the slide show reflecting the memory.

As the display effect, besides enlargement of the face, there is a possible method of gradually zooming in on the face. In this case, a plurality of enlarged image data having different enlargement ratios are inserted. Alternatively, after zooming in, the display effect of gradually zooming out may be applied.

Further, there is a case where a plurality of figures of persons are included in the picked-up image. In this case, images obtained by enlarging the respective face images of the persons may be inserted. In this case, in the slide show, the close-up images of the respective faces of the persons are sequentially displayed one by one. In a case where there is an image obtained by taking a memorial photograph of four persons at a memorial place, following the photograph representing a whole scene, the respective faces of the persons are enlargedly displayed one by one.

Application of the display effect according to the face recognition result can be switched to on/off by the user.

<Smile Recognition Function>

Next, discussion will be made on a smile recognition function of the synthesizing part 101. To the picked-up image data in which a smile evaluation value can be acquired out of the picked-up image data 21 constituting the slide show, the synthesizing part 101 applies a display effect according to the smile evaluation value. As one of methods of acquiring the smile evaluation value is, for example, there is a case where the smile evaluation value is recorded in advance in the tag information of the picked-up image data 21. Specifically, a smile recognition process is applied to the image data picked up by the camera 11 in the control part 10, and the image data is stored in the built-in memory 17 as the picked-up image data 21 with its smile evaluation value included in the tag information. In this case, the synthesizing part 101 refers to the tag information, and when the smile evaluation value is recorded, the synthesizing part 101 applies the display effect according to the smile evaluation value. Alternatively, the synthesizing part 101 may perform the smile recognition process in generation of the synthetic image data 22, to thereby acquire the smile evaluation value.

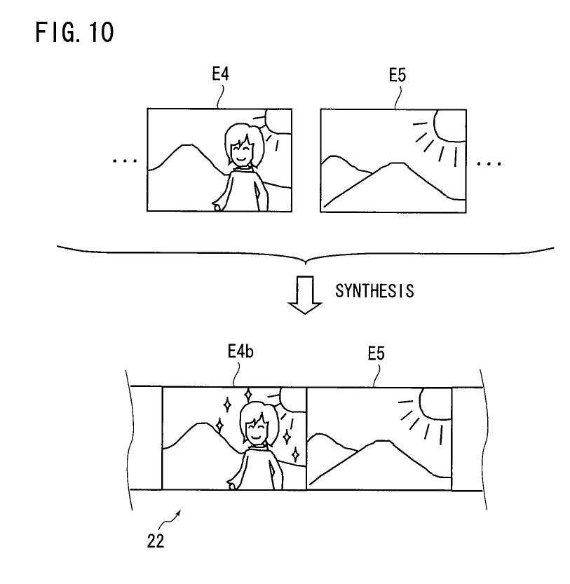

In the exemplary case of FIG. 10, like in the case of FIG. 9, the synthetic image data 22 including the picked-up image data E4 and E5 is generated. The picked-up image data E4 includes a figure of person and its smile evaluation value is recorded in the tag information. Then, the synthesizing part 101 applies the display effect according to the smile evaluation value to the picked-up image data E4 and generates the synthetic image data 22. In the case of FIG. 10, as the smile evaluation value of the person included in the picked-up image data E4, a high evaluation value is recorded. Then, the synthetic image data 22 is generated by using new edit image data E4b decorated by twinkling stars, instead of the picked-up image data E4.

The display effects to be applied according to the smile evaluation values may be prepared as templates. For example, if the smile evaluation value is maximum, a template decorated by stamps of heart mark is applied, and if the smile evaluation value is low, a template casting a dark shadow on the face is applied. This achieves a synthetic image that extravagantly represents the air of the subject and gives more fun. Thus, by applying the display effect according to the smile evaluation value, a visual effect with more impact can be achieved. The templates may be stored in the built-in memory 17 or the memory card 18, or may be acquired from a storage server on a network.

Application of the display effect according to the smile recognition result can be switched to on/off by the user.

<Function of Adding Information Related to Image Pickup Area>

Next, discussion will be made on a function of inserting a slide related to the image pickup area. The synthesizing part 101 refers to the tag information of the picked-up image data 21 and acquires the image pickup area information in generation of the synthetic image data 22. Then, the synthesizing part 101 inserts another slide related to the image pickup area in the synthetic image data 22.

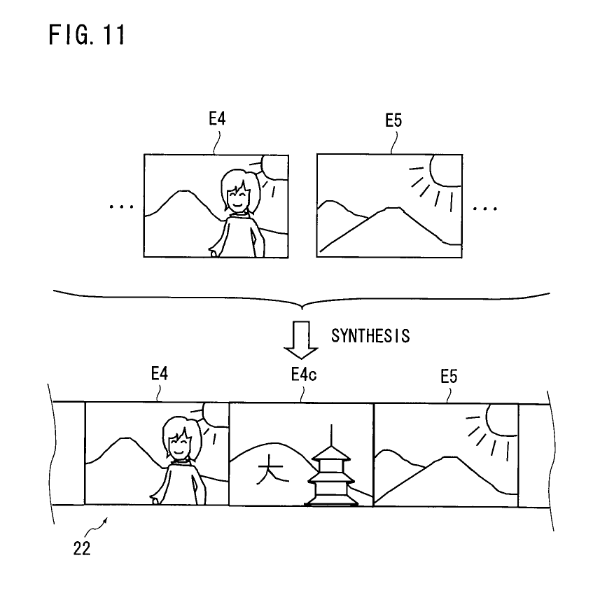

In the exemplary case of FIG. 11, like in the case of FIG. 9, the synthetic image data 22 including the picked-up image data E4 and E5 is generated. The image pickup area information (longitude and latitude information) is recorded in the tag information of the picked-up image data E4. Then, the synthesizing part 101 acquires another related image data E4c related to the image pickup area information and inserts the related image data E4c in between the picked-up image data E4 and the picked-up image data E5, to thereby generate the synthetic image data 22.

In the case of FIG. 11, as the image pickup area information, the longitude and latitude information of Kyoto City is recorded in the tag information of the picked-up image data E4. The synthesizing part 101 acquires the related image data E4c related to Kyoto City from a related image database on the basis of the longitude and latitude information and inserts the related image data E4c in the synthetic image data 22. Thus, it is possible to enhance the presence according to the scene.

The related image database is constructed in another storage server on a network such as the internet. The synthesizing part 101 accesses the related image database via the communication part 15 and acquires the related image data on the basis of the longitude and latitude information. Alternatively, the related image database may be stored in the built-in memory 17 of the cellular phone terminal 1. Further, the related image database may be stored in the memory card 18. In this case, by inserting the memory card 18 storing the related image database therein in the card slot of the cellular phone terminal 1, the user can access the related image database.

Though discussion has been made herein on the case where the image related to the image pickup area information is acquired and the related image data is inserted in the synthetic image, there may be another case where sound effects and BGM related to the image pickup area information are acquired and the sound and voice are added to the synthetic image data 22. If the image pickup area is France, for example, by combining the synthetic image data 22 with the national anthem of France as BGM, the slide show with more presence can be enjoyed.

Application of the display effect related to the image pickup area can be switched to on/off by the user.

<Flow of Synthesizing Process>

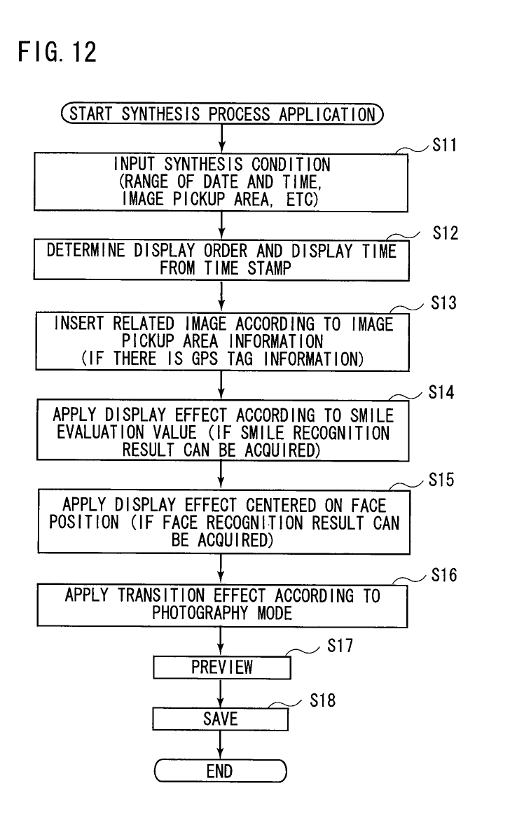

As discussed above, the cellular phone terminal 1 of the first preferred embodiment applies various display effects and generates the synthetic image data 22. An operation flow of the synthesis process will be discussed with reference to the flowchart of FIG. 12. The flowchart of FIG. 12 shows a flow of operation performed by the synthesizing part 101. The synthesizing part 101 is a processing part implemented by starting a synthesis process application program.

First, the synthesizing part 101 displays the condition setting screen for a synthesis condition on the monitor 13 and inputs the synthesis condition (Step S11). The synthesizing part 101 displays, for example, such a condition setting screen as shown in FIG. 3 or 5 on the monitor 13 and inputs the condition designated by the user.

Next, the synthesizing part 101 acquires the picked-up image data 21, 21 . . . that match the synthesis condition. If the image pickup date and time is specified as the synthesis condition, for example, the synthesizing part 101 acquires the image pickup date and time information (time stamp) from the tag information of the picked-up image data 21, 21 . . . stored in the built-in memory 17 and acquires the picked-up image data 21, 21 . . . that match the synthesis condition. Alternatively, if the image pickup area is specified as the synthesis condition, for example, the synthesizing part 101 acquires the picked-up image data 21, 21 . . . obtained in the specified image pickup area out of the picked-up image data 21, 21 . . . stored in the built-in memory 17. Further, from the image pickup date and time of the acquired picked-up image data 21, 21 . . . , the synthesizing part 101 determines the display order and the display time of the slide show (Step S12). As the display order, as discussed above, the ascending order of the image pickup date and time, the descending order of the image pickup date and time, or the like can be set. The display time is set so that the images of which the image pickup times are continuous may be grouped, as discussed with reference to FIG. 7.

Next, the synthesizing part 101 refers to the tag information, and if the image pickup area information can be acquired, the synthesizing part 101 acquires the related image data related to the image pickup area and inserts the data in between the picked-up image data (Step S13). As discussed above, if the image is picked up in Kyoto, for example, another related image data related to Kyoto is inserted.

Next, if the smile recognition result can be acquired, the synthesizing part 101 applies the display effect according to the smile evaluation value (Step S14). As discussed above, if the smile evaluation value is high, for example, the template of twinkling stars is overlaid on the image. If the face recognition result can be acquired, the synthesizing part 101 applies the display effect centered on the face (Step S15). As discussed above, for example, such a display effect as to zoom in/zoom out the image of the face is applied.

Subsequently, the synthesizing part 101 acquires the photography mode information from the tag information of the picked-up image data and applies the transition effect according to the photography mode (Step S16).

After generating the synthetic image data 22 through the above operation, the synthesizing part 101 performs preview display of the generated synthetic image data 22 on the monitor 13 (Step S17). Then, the synthesizing part 101 stores the generated synthetic image data 22 into the built-in memory 17 (Step S18). At that time, as discussed above, it is a great convenience if the event name, the date, or the like are included in the file name of the synthetic image data 22.

The synthesizing part 101 automatically performs the above Steps S12 to S16. Therefore, it is possible for the user to easily generate the synthetic image data 22 by using the cellular phone terminal 1 without any complicated edit operation.

### The Second Preferred Embodiment

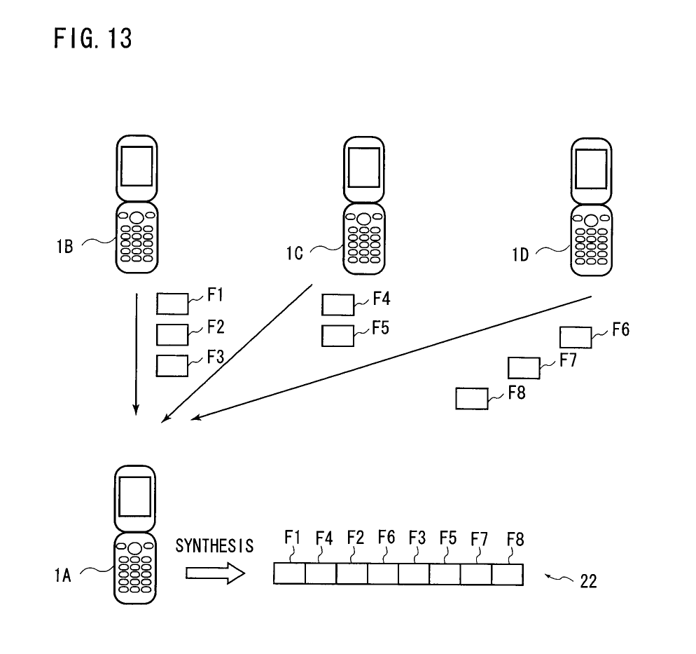

Next, discussion will be made on the second preferred embodiment. In the second preferred embodiment, the synthesis method is the same as that in the first preferred embodiment. In the first preferred embodiment, the cellular phone terminal 1 generates the synthetic image data 22 on the basis of the plurality of picked-up image data 21, 21 . . . stored in the built-in memory 17. In the second preferred embodiment, as shown in FIG. 13, a cellular phone terminal 1A generates the synthetic image data 22 by collecting the picked-up image data from a plurality of cellular phone terminals 1B, 1C, and 1D.

In FIG. 13, the cellular phone terminal 1A operates as a master terminal and performs the same synthesis process as that in the first preferred embodiment. On the other hand, the cellular phone terminals 1B, 1C, and 1D operate as slave terminals and send a plurality of picked-up image data to the cellular phone terminal 1A. In the exemplary case of FIG. 13, the cellular phone terminal 1B sends picked-up image data F1, F2, and F3 to the cellular phone terminal 1A, the cellular phone terminal 1C sends picked-up image data F4 and F5 to the cellular phone terminal 1A, and the cellular phone terminal 1D sends picked-up image data F6, F7, and F8 to the cellular phone terminal 1A.

Then, the cellular phone terminal 1A uses the received picked-up image data F1 to F8 to generate the synthetic image data 22. The method of generating the synthetic image data 22 by the cellular phone terminal 1A is the same as that in the first preferred embodiment.

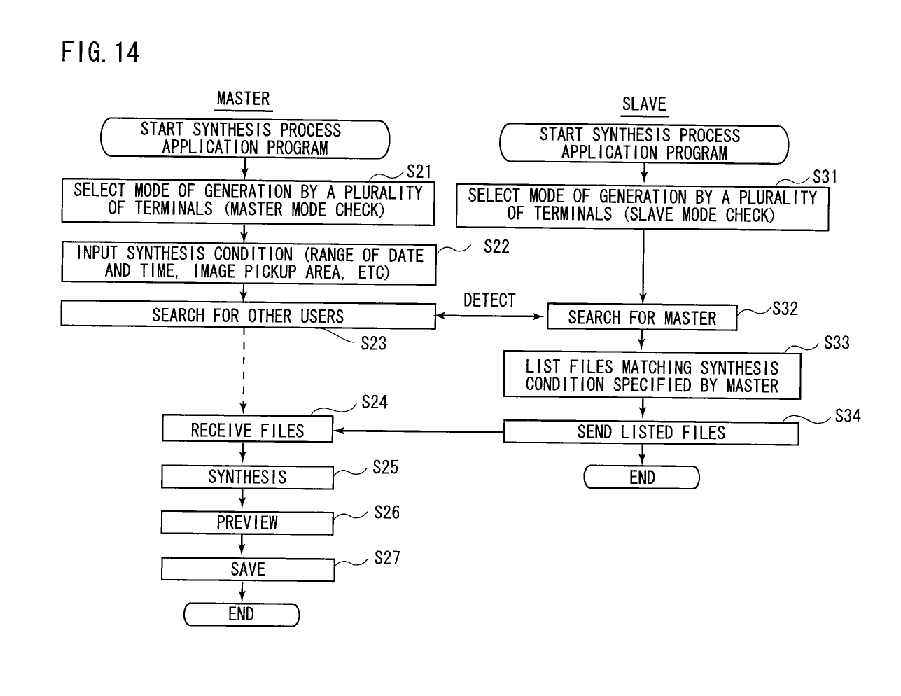

FIG. 14 is a flowchart showing an operation flow of performing the synthesis process among the plurality of cellular phone terminals. This flowchart is divided into an operation of the cellular phone terminal 1A (hereinafter, referred to as a master terminal as appropriate) and an operation of the cellular phone terminals 1B to 1D (hereinafter, referred to as slave terminals as appropriate). These operations are performed according to the start-up of the synthesis process application program in the cellular phone terminals 1A to 1D.

First, the master terminal and the slave terminals select a mode for generation of a synthetic image by a plurality of terminals (Steps S21 and S31). The cellular phone terminal 1A selects a master mode and the cellular phone terminals 1B to 1D select a slave mode.

Next, the master terminal inputs the synthesis condition (Step S22). This operation is the same as that in Step S11 of FIG. 12.

Subsequently, the master terminal searches for the other users (slave terminals) (Step S23). The slave terminals search for the master terminal (Step S32). The communication between the cellular phone terminals may be performed via the mobile phone network, and may be performed via wireless communication, such as Bluetooth or infrared communication, if the cellular phone terminals can use their communication functions. Alternatively, the communication may be performed via cable by connecting the cellular phone terminals with cable.

When the master terminal detects the slave terminals and the slave terminals detect the master terminal, the slave terminals acquire the synthesis condition that the master terminal inputs and list the files that match the synthesis condition (Step S33). Specifically, the cellular phone terminals 1B to 1D acquire the synthesis condition that the cellular phone terminal 1A inputs and extract the picked-up image data that match the synthesis condition out of the picked-up image data stored in the cellular phone terminals 1B to 1D.

Subsequently, the slave terminals send the listed files to the master terminal (Step S34). Specifically, as shown in FIG. 13, the cellular phone terminals 1B to 1D send the picked-up image data F1 to F8 to the cellular phone terminal 1A.

The master terminal receives the transferred files (Step S24) and performs the synthesis process (Step S25). The synthesis process corresponds to Steps S12 to S16 of FIG. 12. Then, the master terminal displays the synthetic image data 22 for preview on the monitor (Step S26) and saves the data (Step S27).

Thus, since the cellular phone terminal 1A uses the picked-up image data stored in the plurality of cellular phone terminals 1B to 1D to thereby generate the synthetic image data 22, it is possible to generate one piece of synthetic image data 22 on the basis of the images picked up by a lot of persons.

For example, one piece of synthetic image data 22 can be generated by collecting the picked-up image data of a sports meeting which are picked up by a plurality of cellular phone terminals owned by a plurality of persons, respectively. Further, at a baseball field, by collecting image data picked up from various angles by a plurality of persons, one piece of synthetic image data 22 can be generated.

### Other Preferred Embodiment

Though discussion has been made on the case where the picked-up image data 21 and the synthetic image data 22 are stored in the built-in memory 17 in the above preferred embodiments, as a matter of course, these data may be stored in the memory card 18.

Though subject data to be synthesized are the picked-up image data 21, 21 . . . stored in the built-in memory 17 in the above preferred embodiments, picked-up image data 21, 21 . . . stored in a specific folder may be subject data to be synthesized. For example, the picked-up image data 21, 21 . . . stored in a current folder may be subject data to be synthesaized. Alternatively, a folder may be specified in the setting screen of FIG. 3, 5, or the like.

Though discussion has been made with a cellular phone terminal taken as an exemplary terminal for performing the synthesis process in the above preferred embodiments, the present invention can be applied to a digital camera, a digital movie, and the like. In other words, the synthesis process may be performed not only on the still image data but also on the moving image data. Further, the present invention can be applied to a portable mobile terminal including a PDA (Personal Digital Assistant) provided with a camera function.

Though discussion has been made on the case where the still image data are synthesized in the above preferred embodiments, if sound and voice are added to the still image data, the still image data together with the sound and voice data may be synthesized. In a case of moving image, the moving image data together with sound and voice may be synthesized.

While the invention has been shown and described in detail, the foregoing description is in all aspects illustrative and not restrictive. It is therefore understood that numerous modifications and variations can be devised without departing from the scope of the invention.

1. A multimedia synthetic data generating apparatus comprising:
means for setting a synthesis condition to generate multimedia synthetic data;
means for acquiring a plurality of multimedia material selection data that match said synthesis condition which is set, out of a plurality of multimedia material data stored in a storage medium; and
means for generating said multimedia synthetic data from said plurality of acquired multimedia material selection data.

2. The multimedia synthetic data generating apparatus according to claim 1, wherein
said plurality of multimedia material data include picked-up image data, and
the range of date and time when said plurality of multimedia material data are picked up is set as said synthesis condition.

3. The multimedia synthetic data generating apparatus according to claim 1, wherein
said plurality of multimedia material data include picked-up image data, and
an area where said plurality of multimedia material data are picked up is set as said synthesis condition.

4. The multimedia synthetic data generating apparatus according to claim 2, wherein
said multimedia synthetic data is slide data which switchingly displays said plurality of multimedia material selection data with the passage of time, and
a timing for slide switching is determined in accordance with an interval of image pickup times of multimedia material selection data.

5. The multimedia synthetic data generating apparatus according to claim 2, wherein
said multimedia synthetic data is slide data which switchingly displays said plurality of multimedia material selection data with the passage of time, and
a transition effect applied to slide switching is determined in accordance with an image pickup mode of each multimedia material selection data.

6. The multimedia synthetic data generating apparatus according to claim 2, wherein
said multimedia synthetic data is slide data which switchingly displays said plurality of multimedia material selection data with the passage of time, and
face recognition is performed in each multimedia material selection data and when the multimedia material selection data is displayed, a display effect centered on a face position is applied.

7. The multimedia synthetic data generating apparatus according to claim 2, wherein
said multimedia synthetic data is slide data which switchingly displays said plurality of multimedia material selection data with the passage of time, and
smile recognition is performed in each multimedia material selection data and when the multimedia material selection data is displayed, a display effect according to the degree of smile is applied.

8. The multimedia synthetic data generating apparatus according to claim 2, wherein
said multimedia synthetic data is slide data which switchingly displays said plurality of multimedia material selection data with the passage of time, and
when each multimedia material selection data is displayed, a display effect in accordance with an image pickup area is applied.

9. The multimedia synthetic data generating apparatus according to claim 8, wherein
related data related to said image pickup area is acquired from a predetermined database and said multimedia synthetic data is synthesized with said related data.

10. A multimedia synthetic data generating apparatus comprising:
means for setting a synthesis condition to generate multimedia synthetic data;
means for acquiring a plurality of multimedia material selection data that match said synthesis condition which is set, out of a plurality of multimedia material data stored in a plurality of storage media included in a plurality of terminals, via communication; and
means for generating said multimedia synthetic data from said plurality of acquired multimedia material selection data.

11. The multimedia synthetic data generating apparatus according to claim 10, wherein
said plurality of multimedia material data include picked-up image data, and
the range of date and time when said plurality of multimedia material data are picked up is set as said synthesis condition.

12. The multimedia synthetic data generating apparatus according to claim 10, wherein
said plurality of multimedia material data include picked-up image data, and
an area where said plurality of multimedia material data are picked up is set as said synthesis condition.

13. The multimedia synthetic data generating apparatus according to claim 11, wherein
said multimedia synthetic data is slide data which switchingly displays said plurality of multimedia material selection data with the passage of time, and
a timing for slide switching is determined in accordance with an interval of image pickup times of each multimedia material selection data.

14. The multimedia synthetic data generating apparatus according to claim 11, wherein
said multimedia synthetic data is slide data which switchingly displays said plurality of multimedia material selection data with the passage of time, and
a transition effect applied to slide switching is determined in accordance with an image pickup mode of each multimedia material selection data.

15. The multimedia synthetic data generating apparatus according to claim 11, wherein
said multimedia synthetic data is slide data which switchingly displays said plurality of multimedia material selection data with the passage of time, and
face recognition is performed in each multimedia material selection data and when the multimedia material selection data is displayed, a display effect centered on a face position is applied.

16. The multimedia synthetic data generating apparatus according to claim 11, wherein
said multimedia synthetic data is slide data which switchingly displays said plurality of multimedia material selection data with the passage of time, and
smile recognition is performed in each multimedia material selection data and when the multimedia material selection data is displayed, a display effect according to the degree of smile is applied.

17. The multimedia synthetic data generating apparatus according to claim 11, wherein
said multimedia synthetic data is slide data which switchingly displays said plurality of multimedia material selection data with the passage of time, and
when each multimedia material selection data is displayed, a display effect in accordance with an image pickup area is applied.

18. The multimedia synthetic data generating apparatus according to claim 17, wherein
related data related to said image pickup area is acquired from a predetermined database and said multimedia synthetic data is synthesized with said related data.
